(19) United States
(12) Patent Application Publication
(10) Pub. No.: US 2010/0026949 A1
(43) Pub. Date: Feb. 4, 2010

(54) LIQUID CRYSTAL DISPLAY PANEL

(75) Inventors: Yi-Chun Wu, Hualien County (TW); Chien-Chang Lee, Tainan County (TW); Po-Hsien Wang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/479,872

(22) Filed: Jun. 8, 2009

(30) Foreign Application Priority Data
Jul. 31, 2008 (TW) 97129100

(51) Int. Cl. G02F 1/1343

(52) U.S. Cl. 349/139

(57) ABSTRACT

An LCD panel includes a first substrate, a second substrate, pixel units, a liquid crystal layer disposed between the first substrate and the second substrate opposite to each other, and an opposite electrode. Each pixel unit has a first auxiliary electrode, a dielectric layer covering the first auxiliary electrode, and a pixel electrode on the dielectric layer. The first auxiliary electrode includes a transparent conductive pattern on the first substrate and a metal conductive pattern on the transparent conductive pattern. An edge of the pixel electrode and the transparent conductive pattern are partially overlapped. The opposite electrode is disposed between the second substrate and the liquid crystal layer. Liquid crystal molecules of the liquid crystal layer tilt away from the edge of the pixel electrode when a common voltage is applied to the first auxiliary electrode and the opposite electrode, and a display voltage is applied to the pixel electrode.

### CROSS-REFERENCE TO RELATED APPLICATION

This application claims the priority benefit of Taiwan application serial no. 97129100, filed Jul. 31, 2008. The entirety of the above-mentioned patent application is hereby incorporated by reference herein and made a part of specification.

### BACKGROUND OF THE INVENTION

1. Field of the Invention

The present invention relates to a liquid crystal display (LCD) panel, and more particularly to an LCD panel capable of achieving a wide-viewing-angle effect and characterized by a high aperture ratio.

2. Description of Related Art

By virtue of increasing demands for displays and a rising awareness of environmental protection, an LCD featuring superior properties including high definition, optimal space utilization, low power consumption, and no radiation has gradually become the mainstream product in the market of the displays. To satisfy consumers' demands, the LCD is required to have a high contrast ratio, no gray scale inversion, little color shift, high luminance, full color, high color saturation, high responsive speed, stable display quality, and wide viewing angles.

Generally, the LCD mainly includes two substrates and a liquid crystal layer disposed therebetween. A plurality of pixel units are disposed on one of the substrates to control an orientation of liquid crystal molecules for frame display. A conventional pixel unit includes a plurality of lines including a plurality of scan lines, a plurality of data lines, and a common electrode line for normally displaying images and stabilizing the quality of the displayed images. Said lines are mostly made of metal, and therefore a display aperture ratio of the pixel unit is likely to be affected. Particularly, the common electrode plays the dominant part in increasing or decreasing the aperture ratio of the pixel unit. As a result, the display performance of the conventional LCD is barely satisfactory.

### SUMMARY OF THE INVENTION

The present invention is directed to an LCD panel having a high aperture ratio.

In the present invention, an LCD panel including a first substrate, a second substrate, a plurality of pixel units, an opposite electrode, and a liquid crystal layer is provided. The second substrate is opposite to the first substrate. The pixel units are disposed between the first substrate and the second substrate. Each of the pixel units includes a first auxiliary electrode, a dielectric layer, and a pixel electrode. The first auxiliary electrode includes a transparent conductive pattern and a metal conductive pattern. The transparent conductive pattern is directly disposed on the first substrate, and the metal conductive pattern is directly disposed on the transparent conductive pattern. The dielectric layer covers the first auxiliary electrode, and the pixel electrode is disposed on the dielectric layer. Here, an edge of the pixel electrode is partially overlapped with the transparent conductive pattern. The liquid crystal layer is disposed between the first substrate and the second substrate. The opposite electrode is disposed between the second substrate and the liquid crystal layer. Liquid crystal molecules of the liquid crystal layer tilt away from the edge of the pixel electrode when a common voltage is applied to the first auxiliary electrode, and the opposite electrode and when a display voltage is applied to the pixel electrode.

In an embodiment of the present invention, the first auxiliary electrode surrounds each of the pixel electrodes.

In an embodiment of the present invention, the metal conductive pattern and the pixel electrodes are not overlapped, for example.

In an embodiment of the present invention, each of the pixel units further includes a second auxiliary electrode disposed on the first substrate and electrically connected to the pixel electrodes. Here, the pixel electrodes and the second auxiliary electrode are partially overlapped. The second auxiliary electrode is made of a transparent conductive material. Practically, the pixel electrode has at least an opening exposing a portion of the dielectric layer that is positioned on a portion of the second auxiliary electrode, for example.

In addition, the second auxiliary electrode substantially surrounds the pixel electrode. The first auxiliary electrode is extended from a first side of the pixel electrode to a second side of the pixel electrode, and the first side is opposite to the second side. Each of the pixel electrodes has at least an opening exposing a portion of the dielectric layer that is positioned on a portion of the transparent conductive pattern.

According to the present invention, the first auxiliary electrode of the LCD panel has a high transmittance rate and serves as a common electrode. When the second auxiliary electrode electrically connected to the pixel electrode is selectively formed in the LCD panel together with the first auxiliary electrode, a fringe field effect (FFE) is generated at the edge of the pixel electrode. As such, the LCD panel of the present invention achieves the wide-viewing-angle effect. On the other hand, the high transmittance rate of the first auxiliary electrode is also contributive to an improvement of a transmittance rate of the LCD panel.

To make the above and other features and advantages of the present invention more comprehensible, several embodiments accompanied with figures are detailed as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A is a schematic top view of a portion of an LCD panel according to a first embodiment of the present invention.

FIG. 1B is a cross-sectional partial view of the LCD panel depicted in FIG. 1A along a sectional line I-I′.

FIG. 2A is a schematic top view of a portion of an LCD panel according to a second embodiment of the present invention.

FIG. 2B is a cross-sectional partial view of the LCD panel depicted in FIG. 2A along a sectional line II-II′.

FIG. 3A is a schematic top view of a portion of an LCD panel according to a third embodiment of the present invention.

FIGS. 3B and 3C are cross-sectional partial views of the LCD panel depicted in FIG. 3A along sectional lines III-III′ and IV-IV′.

FIG. 4A is a schematic top view of a portion of an LCD panel according to a fourth embodiment of the present invention.

FIG. 4B is a cross-sectional partial view of the LCD panel depicted in FIG. 4A along a sectional line V-V′.

### DESCRIPTION OF EMBODIMENTS

Conventionally, issues regarding a restricted display aperture ratio of an LCD panel due to an arrangement of conductive circuits in the LCD panel are not well resolved. Hence, a conductive circuit formed by stacking a transparent conductive pattern and a metal conductive pattern is proposed. Here, the width of the transparent conductive pattern and the width of the metal conductive pattern can be both adjusted based on different demands on design. By forming said conductive circuit into a display region of an LCD panel, a light transmittance rate of the LCD panel can be elevated. Namely, the display aperture ratio of the LCD panel in a transmissive display mode can be increased. Several embodiments are provided hereinafter to elaborate the present invention which should not be construed as limited to the embodiments set forth herein.

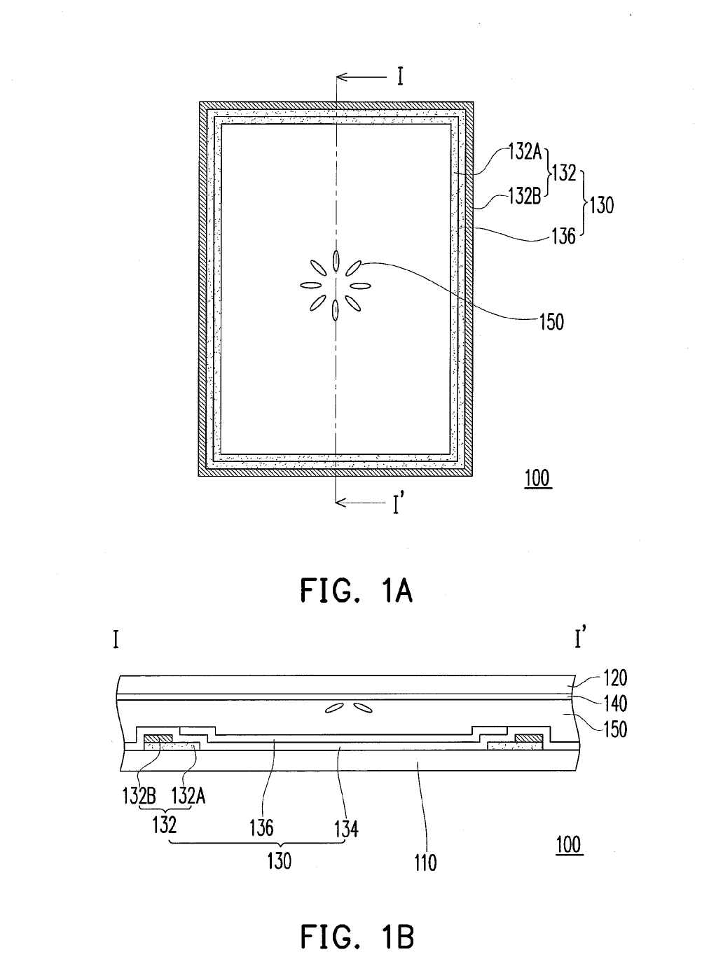

FIG. 1A is a schematic top view of a portion of an LCD panel according to a first embodiment of the present invention. FIG. 1B is a cross-sectional partial view of the LCD panel depicted in FIG. 1A along a sectional line I-I′. Referring to FIGS. 1A and 1B, an LCD panel 100 includes a first substrate 110, a second substrate 120, a plurality of pixel units 130, an opposite electrode 140, and a liquid crystal layer 150. Note that only one pixel unit 130 is depicted in the present embodiment for better illustration. The second substrate 120 is opposite to the first substrate 110. The pixel unit 130 of the present embodiment is disposed on the first substrate 110 and located between the first substrate 110 and the second substrate 120. Likewise, the liquid crystal layer 150 is sandwiched between the first substrate 110 and the second substrate 120. The opposite electrode 140 is disposed between the second substrate 120 and the liquid crystal layer 150.

Each of the pixel units 130 includes a first auxiliary electrode 132, a dielectric layer 134, and a pixel electrode 136. The first auxiliary electrode 132 includes a transparent conductive pattern 132A and a metal conductive pattern 132B. The transparent conductive pattern 132A is directly disposed on the first substrate 110, while the metal conductive pattern 132B is directly disposed on the transparent conductive pattern 132A. The dielectric layer 134 covers the first auxiliary electrode 132, and the pixel electrode 136 is disposed on the dielectric layer 134. Here, an edge of the pixel electrode 136 and the transparent conductive pattern 132A are partially overlapped. As a matter of fact, the pixel units 130 can further include scan lines, data lines, active devices, alignment layers, and other devices that are not depicted in the drawings. In addition, the dielectric layer 134 is a single-layered dielectric layer according to the present embodiment, while the dielectric layer 134 can further include two insulation layers (a gate insulation layer and an inter-layer insulation layer) or more in other embodiments.

Note that liquid crystal molecules of the liquid crystal layer 150 tilt away from the edge of the pixel electrode 136 when a common voltage is applied to the first auxiliary electrode 132 and the opposite electrode 140, and when a display voltage is applied to the pixel electrode 136. Practically, the first auxiliary electrode 132 surrounds the pixel electrode 136 in the present embodiment. When the LCD panel 100 performs a display function, different voltages are respectively applied to the pixel electrode 136 and the first auxiliary electrode 132. Thereby, the non-uniform electric field is induced near the edge of the pixel electrode 136 when the LCD panel 100 performs the display function, thus resulting in the generation of an FFE.

The liquid crystal molecules of the liquid crystal layer 150 affected by the FFE are then arranged in specific manners. For instance, the liquid crystal molecules of the liquid crystal layer 150 are likely to tilt away from the edge of the pixel electrode 136, such that the liquid crystal molecules are arranged in various directions. That is to say, when the first auxiliary electrode 132 surrounds the pixel electrode 136, the FFE generated around the pixel electrode 136 leads to the multi-domain alignment of the liquid crystal molecules of the liquid crystal layer 150, such that a display effect of the wide viewing angle can be achieved. Here, the tilting of the liquid crystal molecules depicted in FIGS. 1A and 1B is merely exemplary, while the liquid crystal molecules of the liquid crystal layer 150 are in fact likely to be arranged in different manners on account of an interaction among the liquid crystal molecules.

The first auxiliary electrode 132 substantially acts as a common electrode in the present embodiment. To stabilize the display images, the common electrode and the pixel electrode 136 should be partially overlapped in most cases, so as to form an appropriate storage capacitor. Nonetheless, the conventional common electrode is made of a metallic material. Thus, in the ordinary course of design, the negative impact of the common electrode on the display aperture ratio of the conventional LCD panel in the transmissive display mode is unlikely to be alleviated. According to the present embodiment, the first auxiliary electrode 132 serving as the common electrode is formed by stacking the transparent conductive pattern 132A and the metal conductive pattern 132B. When the transparent conductive pattern 132A of the first auxiliary electrode 132 is partially overlapped with the pixel electrode 136, the display aperture ratio of the LCD panel 100 is not restricted by the common electrode. In other words, the metal conductive pattern 132B of the present embodiment is not overlapped with the pixel electrode 136, so as not to affect the display aperture ratio.

Specifically, the first auxiliary electrode 132 is designed to have extremely high transmittance mainly for alleviating the negative impact of the conductive circuit on the light transmittance rate of the LCD panel 100. Even considering the satisfactory electrical conductivity of a metallic material which is extensively applied to various electronic products and is used to form conductive lines of the LCD panel 100 for improving the quality of signal transmission, the unfavorable light transmittance rate caused by the metallic conductive lines results in a reduction of the display aperture ratio.

To ensure a satisfactory display aperture ratio without sacrificing the quality of signal transmission, the present invention teaches stacking the transparent conductive pattern 132A and the metal conductive pattern 132B. Here, the transparent conductive pattern 132A has a great light transmittance rate but unremarkable electrical conductivity, while the metal conductive pattern 132B is characterized by great electrical conductivity but a mediocre light transmittance rate. Besides, in the present invention, the transparent conductive pattern 132A is disposed on regions requiring favorable light transmittance, while the transparent conductive pattern 132A and the metal conductive pattern 132B are simultaneously disposed on other regions requiring barely satisfactory light transmittance. As such, the first auxiliary electrode 132 characterized by proper electrical conductivity can also enable the LCD panel 100 to have a great light transmittance rate, so as to efficaciously improve the display aperture ratio.

In the present embodiment, the pixel electrode 136 and the first auxiliary electrode 132 are electrically independent, and thereby the liquid crystal molecules of the liquid crystal layer 150 can be arranged in the multi-domain alignment. The appropriate storage capacitor can be formed in the overlapping portion between the first auxiliary electrode 132 and the pixel electrode 136, so as to maintain the display voltage of the pixel units 130. Additionally, the transparent conductive pattern 132A of the first auxiliary electrode 132 is overlapped with the pixel electrode 136. As a result, the LCD panel 100 can have great display quality by at least obtaining a favorable display aperture ratio, achieving the wide-viewing-angle effect, and stabilizing the display images.

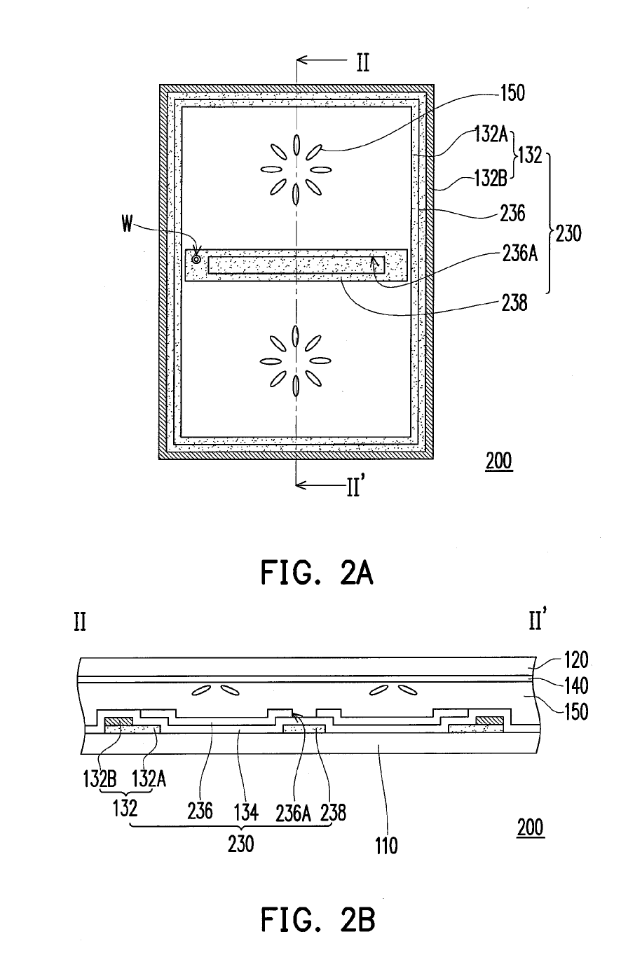

FIG. 2A is a schematic top view of a portion of an LCD panel according to a second embodiment of the present invention. FIG. 2B is a cross-sectional partial view of the LCD panel depicted in FIG. 2A along a sectional line II-II′. Referring to both FIGS. 2A and 2B, an LCD panel 200 of the present embodiment is similar to the LCD panel 100 of the first embodiment. Same reference numbers in FIGS. 2A and 2B represent the same elements as those in FIGS. 1A and 1B. In fact, a pixel unit 230 of the LCD panel 200 further includes a second auxiliary electrode 238 electrically connected to a pixel electrode 236.

In the present embodiment, the second auxiliary electrode 238 is directly disposed on the first substrate 110 and located in a region surrounded by the first auxiliary electrode 132, i.e., a region where the pixel electrode 236 is positioned. The second auxiliary electrode 238 is, for example, electrically connected to the pixel electrode 236 by a contact window W. Practically, the second auxiliary electrode 238 and the transparent conductive pattern 132A of the first auxiliary electrode 132 are in the same film layer. Namely, the second auxiliary electrode 238 is made of a transparent conductive material. Further, the dielectric layer 134 covers the second auxiliary electrode 238, and the pixel electrode 236 has an opening 236A exposing a portion of the dielectric layer 134 located on a portion of the second auxiliary electrode 238. Thereby, when the LCD panel 200 performs the display function, the arrangement of the second auxiliary electrode 238 affects the distribution of the electric field in the liquid crystal layer 150, such that the LCD panel 200 accomplishes the wide-viewing-angle effect.

In particular, when images at a specific gray level are displayed by the LCD panel 200, the liquid crystal molecules of the liquid crystal layer 150 are arranged in a certain manner because of a voltage difference between the opposite electrode 140 and the pixel electrode 236. According to the present embodiment, the same voltage, i.e., the display voltage, is applied to both the pixel electrode 236 and the second auxiliary electrode 238. The voltage difference between the pixel electrode 236 and the opposite electrode 140 is equal to the voltage difference between the second auxiliary electrode 238 and the opposite electrode 140. Nevertheless, the distance between the second auxiliary electrode 238 and the opposite electrode 140 is different from the distance between the pixel electrode 236 and the opposite electrode 140. Besides, the same electrical property and the relative distance of the pixel electrode 236 and the second auxiliary electrode 238 lead to deformed electric field distribution, such that the non-uniform electric field distribution is induced in the liquid crystal layer 150.

The non-uniform electric field distribution results in the generation of the FFE near an edge of the opening 236A surrounded by the pixel electrode 236, and thereby the arrangement of the liquid crystal molecules of the liquid crystal layer 150 is affected. On the other hand, the first auxiliary electrode 132 of the present embodiment surrounds the pixel electrode 236. When the LCD panel 200 performs the display function, a common voltage is applied to the first auxiliary electrode 132. Thus, the disposition of the first auxiliary electrode 132 also induces the generation of the FFE around the edge of the pixel electrode 236. In the light of the pixel unit 230 as a whole, the liquid crystal molecules in different regions of the liquid crystal layer 150 are affected by the non-uniform electrical field. Consequently, the liquid crystal molecules are arranged in the multi-domain alignment.

For instance, due to the FFE generated by the first auxiliary electrode 132 and the second auxiliary electrode 238 in the pixel unit 230, the liquid crystal molecules of the liquid crystal layer 150 tilt away from the first auxiliary electrode 132 and the second auxiliary electrode 238. That is to say, the liquid crystal molecules of the liquid crystal layer 150 are approximately arranged away from the edge of the pixel electrode 236 and are centrically disposed. Thereby, the liquid crystal molecules in the liquid crystal layer 150 are arranged in the multi-domain alignment, such that the LCD panel 200 is able to accomplish the wide-viewing-angle effect.

The second auxiliary electrode 238 is made of a transparent conductive material, and therefore the disposition of the second auxiliary electrode 238 does not pose a negative impact on the display aperture ratio of the LCD panel 200. In addition, it is the transparent conductive pattern 132A of the first auxiliary electrode 132 that is partially overlapped with the pixel electrode 236 according to the present embodiment. Therefore, the LCD panel 200 can have a relatively high display aperture ratio.

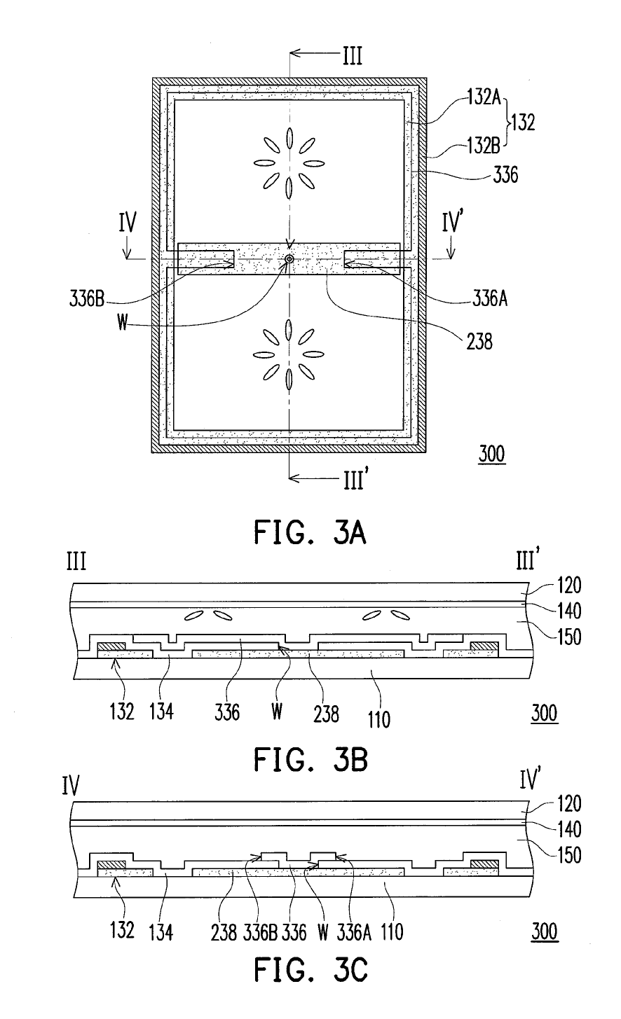

In practice, the region where openings 336A and 336B are disposed and the number of the openings 336A and 336B are not limited in the present invention. A pixel electrode having two openings is provided hereinafter to elaborate the present invention, which should not be construed as limited to the embodiments set forth herein. FIG. 3A is a schematic top view of a portion of an LCD panel according to a third embodiment of the present invention. FIGS. 3B and 3C are cross-sectional partial views of the LCD panel depicted in FIG. 3A along sectional lines III-III′ and IV-IV′. Referring to FIGS. 3A, 3B, and 3C, an LCD panel 300 of the present embodiment is similar to the LCD panel 200 of the second embodiment. Same reference numbers herein represent the same elements provided in the second embodiment, and thus the same elements will not be reiterated. The difference between the LCD panel 300 and the LCD panel 200 lies in that a pixel electrode 336 has two openings 336A and 336B, and the contact window W is, for example, interposed between the openings 336A and 336B.

The open-ended openings 336A and 336B are extended from an edge of the pixel electrode 336 near the first auxiliary electrode 132 to the center of the pixel electrode 336. The openings 336A and 336B expose the dielectric layer 134 disposed on a portion of the second auxiliary electrode 238. When the LCD panel 300 performs a display function, the FFE is generated at the edge of the pixel electrode 336 by the first auxiliary electrode 132 and the second auxiliary electrode 238. The edge of the pixel electrode 336 includes an edge located above the first auxiliary electrode 132 and edges of the open-ended openings 336A and 336B. As such, the LCD panel 300 of the present embodiment achieves the wide-viewing-angle effect. Moreover, the second auxiliary electrode 238 is made of a transparent conductive material, and therefore the second auxiliary electrode 238 disposed in a region where the pixel electrode 336 is located does not result in a reduction of the display aperture ratio of the LCD panel 300. In other words, the LCD panel 300 can be characterized by a favorable display quality.

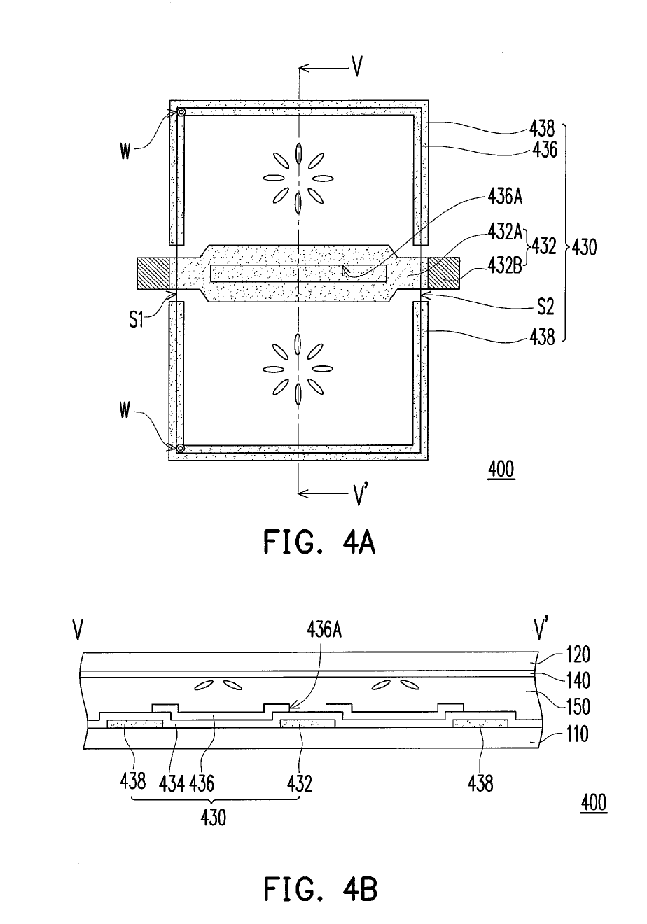

FIG. 4A is a schematic top view of a portion of an LCD panel according to a fourth embodiment of the present invention. FIG. 4B is a cross-sectional partial view of the LCD panel depicted in FIG. 4A along a sectional line V-V′. Referring to FIGS. 4A and 4B, an LCD panel 400 includes a first substrate 110, a second substrate 120, a plurality of pixel units 430, an opposite electrode 140, and a liquid crystal layer 150. The first substrate 110, the second substrate 120, the opposite electrode 140, and the liquid crystal layer 150 of the present embodiment are arranged in the same manner as that of the three embodiments provided hereinbefore, and therefore no further description is provided below. Additionally, only one pixel unit 430 is depicted in the present embodiment for better illustration.

The pixel unit 430 of the present embodiment has a first auxiliary electrode 432, a dielectric layer 434, a pixel electrode 436, and a second auxiliary electrode 438. The first auxiliary electrode 432 and the second auxiliary electrode 438 are directly disposed on the first substrate 110. The dielectric layer 434 covers the first auxiliary electrode 432 and the second auxiliary electrode 438, and the pixel electrode 436 is disposed on the dielectric layer 434. Here, an edge of the pixel electrode 436 and the first auxiliary electrode 432 are partially overlapped, and the pixel electrode 436 is partially overlapped with the second auxiliary electrode 438. Besides, the second auxiliary electrode 438 is electrically connected to the pixel electrode 436 by the contact window W.

The second auxiliary electrode 438 is constituted by two U-shaped transparent conductive patterns facing each other. In addition, the second auxiliary electrode 438 substantially surrounds the pixel electrode 436. The first auxiliary electrode 432 is extended from a first side S1 of the pixel electrode 436 to a second side S2 of the pixel electrode 436, and the first side S1 is opposite to the second side S2. Namely, the first auxiliary electrode 432 passes through the region where the pixel electrode 436 is located.

To generate the proper FFE, the pixel electrode 436 has an opening 436A located above the first auxiliary electrode 432. The opening 436A exposes a portion of the dielectric layer 434 positioned on a portion of the first auxiliary electrode 432. In other words, the edge of the pixel electrode 436 surrounds the opening 436A and is overlapped with the first auxiliary electrode 432. A common voltage is applied to the first auxiliary electrode 432, while a display voltage is applied to the pixel electrode 436. When the LCD panel 400 performs a display function, the voltage difference between the first auxiliary electrode 432 and the pixel electrode 436 gives rise to the generation of the FFE at the edge of the opening 436A. Moreover, the second auxiliary electrode 438 formed by the two U-shaped patterns and surrounding the edge of the pixel electrode 436 also brings about the occurrence of the FFE. Owing to the FFE that is generated by the first auxiliary electrode 432 and the second auxiliary electrode 438, the liquid crystal molecules of the liquid crystal layer 150 tilt away from the edge of the pixel electrode 436. In the present embodiment, the edge of the pixel electrode 436 includes an edge located above the second auxiliary electrode 438 and an edge surrounding the opening 436A.

It should be mentioned that, the first auxiliary electrode 432 is in fact composed of a transparent conductive pattern 432A and a metal conductive pattern 432B. Hence, according to the present embodiment, the display aperture ratio can be prevented from being reduced by the first auxiliary electrode 432 passing through the region where the pixel electrode 436 is disposed. For instance, the transparent conductive pattern 432A of the first auxiliary electrode 432 can be individually disposed in the region where the pixel electrode 436 is disposed, whereas the metal conductive pattern 432B is disposed outside the region where the pixel electrode 436 is disposed. Thereby, the display region, i.e., the region where the pixel electrode 436 is disposed, can have a great light transmittance rate. Meanwhile, the satisfactory signal transmission quality of the first auxiliary electrode 432 can be ensured. According to the present embodiment, the first auxiliary electrode 432 made of two materials having different light transmittance rates leads to the flexibility of designing the LCD panel 400 characterized by a great light transmittance rate.

In light of the foregoing, the transparent conductive pattern and the metal conductive patterned stacked to each other serve as the first auxiliary electrode in the present invention, and therefore the LCD panel of the present invention has a relatively high light transmittance rate. Moreover, in the LCD panel of the present invention, the pixel electrode is overlapped with a portion of the first auxiliary electrode and a portion of the second auxiliary electrode. Thereby, when the LCD panel performs the display function, the non-uniform electric field generated at the edge of the pixel electrode allows the liquid crystal molecules to be arranged in the multi-domain alignment. That is to say, the LCD panel of the present invention is able to achieve the wide-viewing-angle effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
a first substrate;
a second substrate opposite to the first substrate;
a liquid crystal layer, disposed between the first substrate and the second substrate;
a plurality of pixel units, each of the pixel units comprising a first auxiliary electrode, a dielectric layer covering the first auxiliary electrode, and a pixel electrode disposed on the dielectric layer, the first auxiliary electrode comprising a transparent conductive pattern directly disposed on the first substrate and a metal conductive pattern directly disposed on the transparent conductive pattern, wherein an edge of the pixel electrode and the transparent conductive pattern are partially overlapped; and
an opposite electrode, disposed between the liquid crystal layer and the second substrate, wherein liquid crystal molecules of the liquid crystal layer tilt away from the edge of the pixel electrode when a common voltage is applied to the first auxiliary electrode and the opposite electrode, and when a display voltage is applied to the pixel electrode.

2. The liquid crystal display panel as claimed in claim 1, wherein the first auxiliary electrode surrounds each of the pixel electrodes.

3. The liquid crystal display panel as claimed in claim 1, wherein the metal conductive pattern and the pixel electrodes are not overlapped.

4. The liquid crystal display panel as claimed in claim 1, wherein each of the pixel units further comprises a second auxiliary electrode disposed on the first substrate and electrically connected to the pixel electrodes, and the dielectric layer is further disposed between the pixel electrode and the second auxiliary electrode.

5. The liquid crystal display panel as claimed in claim 4, wherein the second auxiliary electrode is made of a transparent conductive material.

6. The liquid crystal display panel as claimed in claim 4, wherein the pixel electrode has at least an opening exposing the dielectric layer that is positioned on a portion of the second auxiliary electrode.

7. The liquid crystal display panel as claimed in claim 4, wherein the second auxiliary electrode substantially surrounds the pixel electrode, the first auxiliary electrode is extended from a first side of the pixel electrode to a second side of the pixel electrode, and the first side is opposite to the second side.

8. The liquid crystal display panel as claimed in claim 7, wherein each of the pixel electrodes has at least an opening exposing the dielectric layer that is positioned on a portion of the transparent conductive pattern.
